(19) United States
(12) Patent Application Publication
(10) Pub. No.: US 2009/0122994 A1
(43) Pub. Date: May 14, 2009

(54) LOCALIZATION CONTROL DEVICE, LOCALIZATION CONTROL METHOD, LOCALIZATION CONTROL PROGRAM, AND COMPUTER-READABLE RECORDING MEDIUM

(75) Inventors: Yoshiki Ohta, Saitama (JP); Kensaku Obata, Saitama (JP)

Correspondence Address: FOLEY AND LARDNER LLP;SUITE 500, 3000 K STREET NW, WASHINGTON, DC, 20007, US

(73) Assignee: pioneer corporation

(21) Appl. No.: 12/090,600

(22) PCT Filed: Oct. 11, 2006
(86) PCT No.: PCT/JP2006/320324

§ 371 Date: Apr. 17, 2008

(30) Foreign Application Priority Data
Oct. 18, 2005 (JP) 2005-303560

(51) Int. Cl. H04R 5/00

(52) U.S. Cl. 381/17

(57) ABSTRACT

A localization control apparatus outputs an input audio signal to one channel among plural channels, and based on the input audio signal, outputs a control signal for controlling an audio signal for another channel among the plural channels. In the localization control apparatus, an attenuating unit attenuates the input audio signal. A delaying unit, according to band, separates and delays the audio signal attenuated by the attenuating unit. A generating unit generates the control signal by combining each component of the audio signal separated and delayed by the delaying unit.

### TECHNICAL FIELD

The present invention relates to a localization control apparatus, a localization control method, a localization control program, and a computer-readable recording medium that changes a position of a sound image of input sound to be played back. Application of the present invention is not limited to the localization control apparatus, the localization control method, the localization control program, and the computer-readable recording medium above.

### BACKGROUND ART

With the spread of DVDs and terrestrial digital broadcasts, content with surround sound such as 5.1-channel surround sound has increased. Many speakers are needed to enjoy 5.1-channel surround sound at home. However, a room has limited space for disposing many speakers. Particularly, in many cases, a speaker cannot be disposed behind a listener.

An apparatus has been disclosed that generates a virtual sound image with two filters satisfying each condition of HI=(SF−AK)/(S²−A²) and Hr=(SK−AF)/(S²−A²) when two front speakers are disposed symmetrically with respect to a listener (see, for example, Patent Document 1). Where S is a transfer function from a pair of speakers to an ear of the listener on the same side, A is a transfer function from the pair of the speakers to the other ear of the listener on the opposite side, F is a transfer function from a position to which the sound image is to be localized to the ear of the listener on the same side, and K is a transfer function from the position to which the sound image is to be localized to the other ear of the listener on the opposite side.

Patent Document 1: Japanese Patent Application Laid-open Publication No. H8-265899

### DISCLOSURE OF INVENTION

### Problem to be Solved by the Invention

However, in a playback sound field, a transfer function to a human ear has various peaks and dips, and cannot be flat in general. A filter coefficient calculated from such a transfer function has a similar characteristic. Thus, a problem arises in that a transfer function of a conventional speaker has a non-flat frequency characteristic, and frequency components of a sound source drastically change, resulting in playback with an unnatural sound quality.

Since listening circumstances and a position of a listener's head are not always constant, and as head-shape varies according to each individual, it is generally difficult to find a filter coefficient effective for every one. On the other hand, even if the filter coefficient can be approximated by an interaural level difference for each band obtained using a desired head-related transfer function (HRTF), the sound image is not localized to an intended position since a human detects the position of the sound image in terms of HRTF+α. Although the configuration can be simpler to adjust the portion of +α, in this case, a problem arises in that a logically optimal solution does not always exist.

Furthermore, head shape and playback circumstances vary depending on a user. In processing that uses the HRTF, another problem arises in that a coefficient optimal for the circumstances cannot be obtained without a measurement using a dummy head. Even if speakers are disposed symmetrically with respect to a listener, in many cases, the coefficient causing a virtual sound image to spread bilaterally the most widely most often is asymmetrical. Circumstances of a room and auditory asymmetry are the factors. As a result, a problem arises in that the virtual sound image does not spread such that the listener can listen comfortably.

### Means for Solving Problem

A localization control apparatus according to the invention of claim 1 outputs an audio signal input thereto to one of a plurality of channels, and based on the audio signal input, outputs a control signal for controlling an audio signal for another channel among the channels. The localization control apparatus includes an attenuating unit that attenuates the audio signal input; a delaying unit that delays the audio signal attenuated by the attenuating unit; and a generating unit that generates the control signal from the audio signal delayed by the delaying unit.

A localization control method according to the invention of claim 7 is for outputting an audio signal input thereto to one of a plurality of channels, and based on the audio signal input, outputting a control signal for controlling an audio signal for another channel among the channels. The localization control method includes an attenuating step of attenuating the audio signal input; a delaying step of delaying the audio signal attenuated at the attenuating step; and a generating step of generating the control signal from the audio signal delayed at the delaying step.

A localization control program according to the invention of claim 8 causes a computer to execute the localization control method according to claim 7.

A computer-readable recording medium according to the invention of claim 9 stores therein the localization control program according to claim 8.

### BRIEF DESCRIPTION OF DRAWINGS

FIG. 1 is a block diagram of a functional configuration of a localization control apparatus according to an embodiment of the present invention;

FIG. 2 is a flowchart of a process of the localization control method according to the embodiment of the present invention;

FIG. 3 is a block diagram for explaining arrangement of the localization control apparatus and speakers;

FIG. 4 is a block diagram of a hardware configuration of the localization control apparatus;

FIG. 5 is a block diagram for explaining a function of left localization performed by the localization control apparatus;

FIG. 6 is a block diagram for explaining a function of localizing two sound images performed by the localization control apparatus;

FIG. 7 is an explanatory diagram of a control principle image upon playback with only a left speaker without any control;

FIG. 8 is an explanatory diagram of a control principle image for rearward localization;

FIG. 9 is an explanatory diagram of reverse-phase sound;

FIG. 10 is an explanatory diagram of a case in which delay is applied;

FIG. 11 is a flowchart for explaining sound-localization control processing; and

FIG. 12 is a block diagram for explaining a configuration of the localization control apparatus when playing back middle-to-high frequency sound with other speakers.

### EXPLANATIONS OF LETTERS OR NUMERALS

101 attenuating unit
102 delaying unit
103 generating unit
104 output unit
301 localization control apparatus
302 speaker
303 speaker
401 stereo terminal
406 sound-source storing unit
500 attenuating unit
510 delaying unit
511 delay device
512 bandpass filter
513 adding unit
600 attenuating unit
601 delaying unit
602 adding unit
610 attenuating unit
611 delaying unit
612 adding unit
1200 center attenuating unit
1201 center delaying unit
1210 right attenuating unit
1211 right delaying unit

### BEST MODE(S) FOR CARRYING OUT THE INVENTION

Referring to the accompanying drawings, exemplary embodiments of the localization control apparatus, the localization control method, the localization control program, and the computer-readable recording medium according to the present invention are explained in detail below.

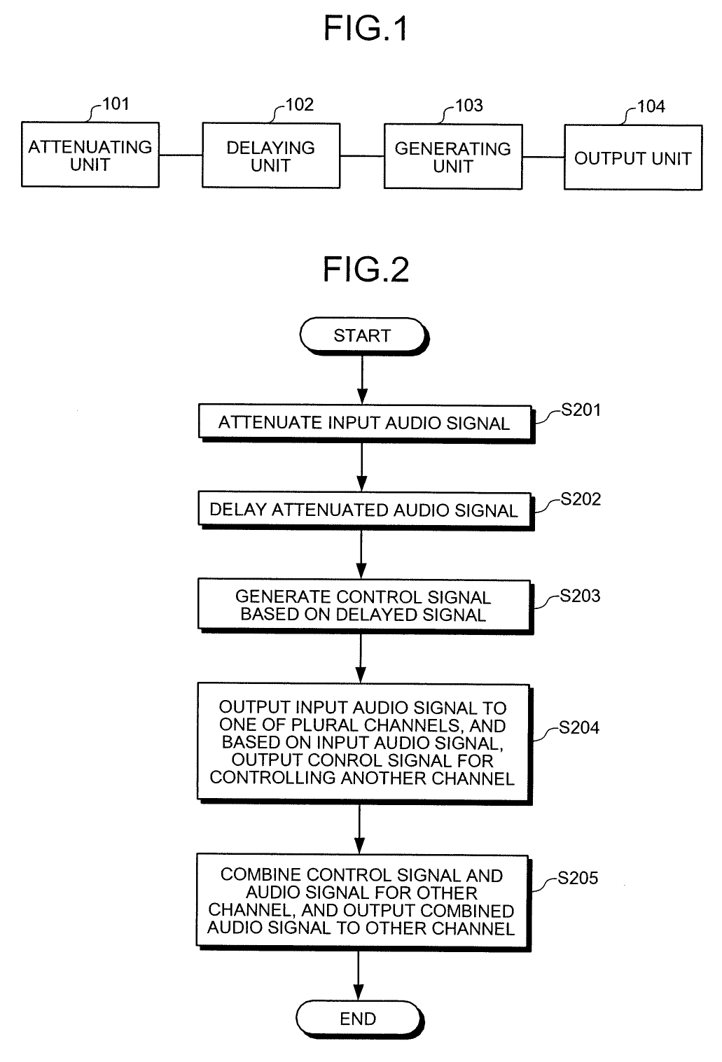

FIG. 1 is a block diagram of a functional configuration of a localization control apparatus according to an embodiment of the present invention. The localization control apparatus of the embodiment outputs an input audio signal to one of plural channels, and based on the input audio signal, outputs a control signal for controlling an audio signal for another channel among the plural channels. The localization control apparatus includes an attenuating unit 101, a delaying unit 102, a generating unit 103, and an output unit 104.

The attenuating unit 101 attenuates the input audio signal. The attenuating unit 101 can attenuate the input audio signal using a bandpass filter. The delaying unit 102 delays the audio signal attenuated by the attenuating unit 101. For example, the delaying unit 102 separates, according to band, the audio signal attenuated by the attenuating unit 101, and delays the audio signal.

The generating unit 103 generates a control signal from the audio signal delayed by the delaying unit 102. For example, the generating unit 103 combines each audio signal for each band that is delayed by the delaying unit 102 to generate the control signal. Additionally, the generating unit 103 can generate a control signal for each of the other channels among the plural channels.

The output unit 104 combines the control signal generated by the generating unit 103 to the audio signal for the other channel among the plural channels, and outputs the combined audio signal to the other channel among the plural channels. By combining the control signal generated by the generating unit 103, the output unit 104 changes a sound pressure level of the audio signal of the other channel among the plural channels to change a position of a sound image of sound corresponding to the audio signal. When the input audio signal is an audio signal to be output to a left speaker, the output unit 104 outputs the input audio signal to the left speaker as it is, and the control signal generated by the generating unit 103 to a right speaker.

FIG. 2 is a flowchart of a process of the localization control method according to the embodiment of the present invention. The attenuating unit 101 attenuates an input audio signal (step S201). The delaying unit 102 delays the audio signal attenuated by the attenuating unit 101 (step S202). The generating unit 103 generates a control signal from the audio signal delayed by the delaying unit 102 (step S203).

The input audio signal is output to one of the plural channels, and based on the input audio signal, a control signal for controlling an audio signal for another channel among the plural channels is output (step S204).

The output unit 104 combines the control signal generated by the generating unit 103 with the audio signal for the other channel, and outputs the combined audio signal to the other channel (step S205). By combining the control signal generated by the generating unit 103 and playing back the combined audio signal, the output unit 104 changes the sound pressure levels at both ears, and the position of the sound image of the sound corresponding to the audio signal.

According to the embodiment explained above, the attenuated and delayed audio signal can be output to the other speaker. As a result, an audio signal output to a speaker is delayed and output to the other speaker, thereby changing sound pressure levels at both ears, for example. As a result, a position of a sound image at a listener can be changed.

Therefore, even when a filter coefficient has a variation such as when listening circumstances and a position of a listener's head are not constant, and when head-shape differs, the filter coefficient can be adjusted accordingly and used. Even if sound for which phase difference alone is changed is played back with one speaker, a difference in the sound quality from that of the original sound can be hardly recognized. Therefore, localization control without reducing the quality of original sound is enabled.

### EXAMPLE

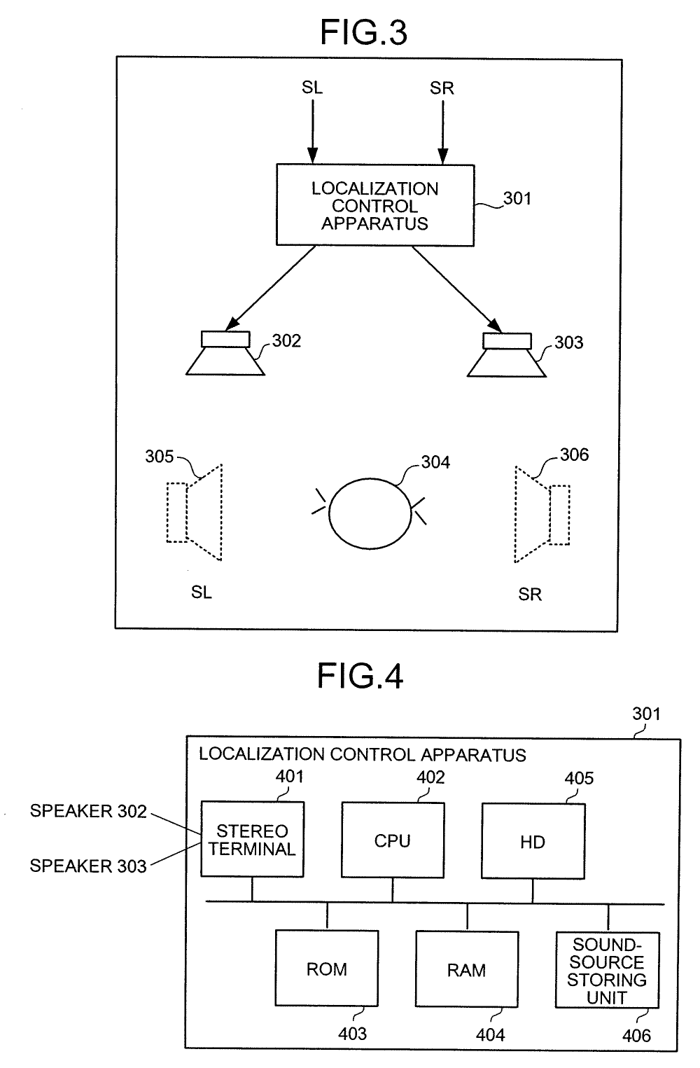

FIG. 3 is a block diagram for explaining arrangement of the localization control apparatus and speakers. Surround signals of SL and SR are input to the localization control apparatus 301. SL is a signal to be output on the left, and SR is a signal to be output to the right. Upon the input of SL and SR, the localization control apparatus 301 generates audio signals, and plays back the audio signals from speakers 302 and 303.

A listener 304 listens to the sound played back from the speakers 302 and 303, the sound played back is in a state in which the localization position of the sound image is changed for the listener 304. As a result, the listener 304 can hear the sound as if the speakers 302 and 303 are disposed at virtual positions 305 and 306.

Usually, 5.1-channel content is played back with three front speakers (L, R, and C) and two rear speakers (SL: surround L, and SR: surround R). A sound image can be virtually localized without the speakers for the SL and the SR channels, and with only the speakers 302 and 303.

Upon hearing sound, a human has sound-image localization ability to acquire not only intensity, elevation, and tone of the sound, but also spatial information such as an orientation and a distance. An orientation of sound can be determined approximately by analyzing and controlling physical factors of sound image localization. A cue of sound image localization includes a time difference and an intensity difference between signals arriving at each ear, a change in a frequency characteristic of a sound wave arising from diffraction at the head, an auricle and the like, and reflection by a wall of a room.

Here, the position of the sound image is changed by changing a level difference of sound. Then, the localization control apparatus 301 changes the sound image, thereby making circumstances such that sound can be approximately heard from the position of the sound image. A human auditory sense recognizes a “sound image” such as a sound-orientation image and intensity of sound by aggregating information such as the time and the level difference between signals arriving both ears.

FIG. 4 is a block diagram of a hardware configuration of the localization control apparatus. The localization control apparatus 301 includes a stereo terminal 401, a CPU 402, a ROM 403, a RAM 404, an HD, and a sound-source storing unit 406.

The stereo terminal 401 is a terminal for outputting sound to the speakers 302 and 303 upon receiving sound output from the CPU 402. The CPU 402 controls the entire localization control apparatus 301 of the example. The ROM 403 stores therein a program such as a boot program. The RAM 404 is used as a work area of the CPU 402. The HD 405 is a nonvolatile and rewritable magnetic memory. The sound-source storing unit 406 stores therein sound sources, and sound is played back by the CPU 402 reading the stored sound sources. For example, the sound sources include a CD and a DVD.

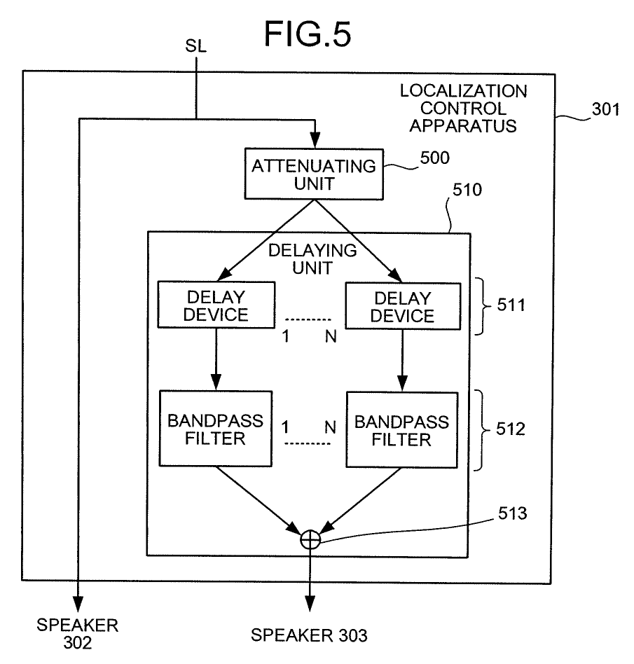

FIG. 5 is a block diagram for explaining a function of left localization performed by the localization control apparatus. A functional configuration of the hardware configuration of the localization control apparatus 301 shown in FIG. 4 is explained. A signal represented by SL is input to the localization control apparatus 301. SL is output as it is to the speaker 302 on the left side of the listener 304. Meanwhile, the same signal is input also to the attenuating unit 500.

The attenuating unit 500 attenuates the input signal by multiplying the input signal by a given coefficient ATT. Here, ATT has a range of 0 to 1, for example ATT=0.5. The attenuating unit 500 attenuates the signal represented by SL by ATT, and outputs the attenuated signal to the delaying unit 510.

The delaying unit 510 includes a delay device 511, a bandpass filter 512, and an adding unit 513. The delay device 511 delays the signal input by the attenuating unit 500 according to a band of the signal. After the delaying, the delay device 511 inputs the delayed signal to bandpass filter 512.

The bandpass filter 512 includes N bandpass filters. The number of the N bandpass filters is determined by the number of bands into which the band of the signal SL is divided. In the case of 6 bands, N=6, and in the case of 9 bands, N=9. Similar to the delay device 511, the bandpass filter 512 is divided according to the number of bands.

The bandpass filter 512 filters, respectively for each band, the signal filtered by the delay device 511. The bandpass filter 512 filters each of the N separated signals according to each respective band. After the filtering, the bandpass filter 512 outputs the filtered signals to the adding unit 513. Although here, the signals are passed through the bandpass filter 512 after being subjected to the delay device 511, the signals may be subjected to the delay processing after the filtering. The adding unit 513 combines the delayed signals corresponding to the bands, and outputs the combined signal to the speaker 303.

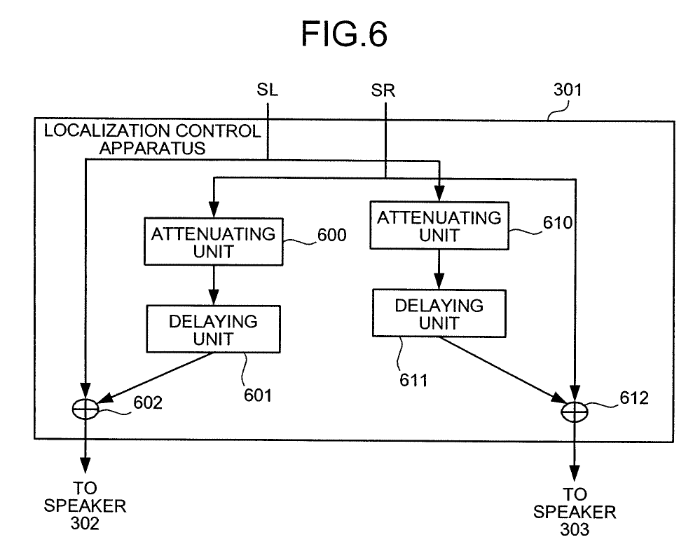

FIG. 6 is a block diagram for explaining a function of localizing two sound images performed by the localization control apparatus. The functional configuration of the hardware configuration of the localization control apparatus shown in FIG. 4 is explained. A filter coefficient calculated from the conventional HRTF is not used in the present example. An unprocessed signal is output from one speaker, and a signal to which delay (phase processing) is applied for each band is output from the other speaker. Although rear components to be virtually localized are two channels in the case of the 5.1-channel system, extension to a case of a 7.1-channel system in which rear components of 4 channels are to be virtually localized is enabled in a similar manner.

A signal represented by SL and a signal represented by SR are input to the localization control apparatus 301. SL is output to the adding unit 602. Meanwhile, the same signal is input to the attenuating unit 610. SR is output to the adding unit 612. Meanwhile, the same signal is input to the attenuating unit 600.

Each of the delaying units 601 and 611 has the same configuration as the delaying unit 510 shown in FIG. 5, and includes the delay device 511, the bandpass filter 512, and the adding unit 513. Each of the delaying units 601 and 611 performs filtering and delaying processing by the delay device 511 and the bandpass filter 512 according to the number of divided bands, respectively combines and outputs the signals. The delaying unit 601 outputs the signal to the adding unit 602, and the delaying unit 611 outputs the signal to the adding unit 612.

The adding unit 602 adds SL and the signal from the delaying unit 601, and outputs the added signal to the speaker 302. The adding unit 612 adds SR and the signal from the delaying unit 611, and outputs the added signal to the speaker 303.

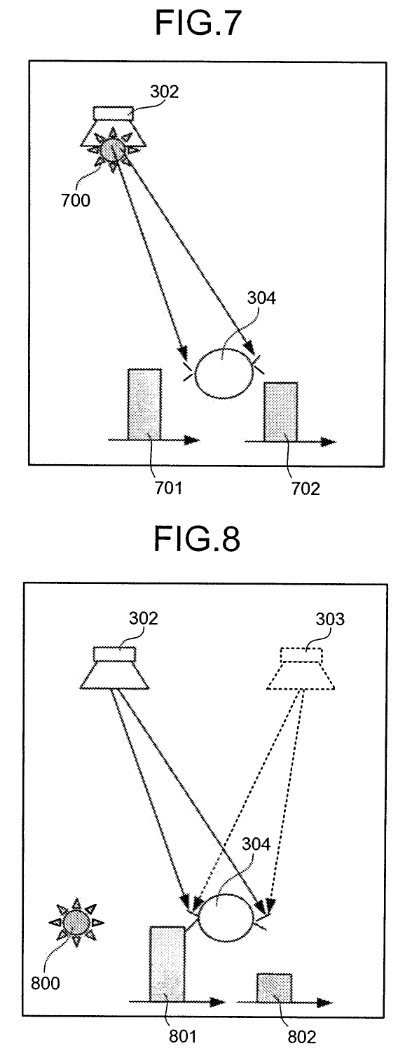

FIG. 7 is an explanatory diagram of a control principle image upon playback with only the left speaker without any control. At this time, a sound image 700 is formed adjacent to the speaker 302. Bars 701 and 702 indicate average sound-pressure levels at the ears of the listener 304. The bar 701 indicates an average sound-pressure level at the left ear of the listener 304, and the bar 702 indicates an average sound-pressure level at the right ear of the listener 304.

The sound pressure indicated by the bar 702 is slightly smaller than that indicated by the bar 701. As a result, the sound image 700 is formed adjacent to the speaker 302. The listener feels as though the sound coming from the sound image 700.

FIG. 8 is an explanatory diagram of a control principle image for rearward localization. A speaker used for control is disposed on the forward right, and the speaker 303 is driven such that the sound-pressure level difference at the both ears increases. As a result, a sound image 800 is localized to leftward from the sound image 700 shown in FIG. 7. A bar 801 indicates an average sound-pressure level at the left ear of the listener 304, and a bar 802 indicates an average sound-pressure level at the right ear of the listener 304.

Not only does the speaker 302 shown in FIG. 7 output sound, but the speaker 303 also outputs sound. As a result, the sound pressures indicated by the bars 701 and 702 shown in FIG. 7 vary as indicated by the bars 801 and 802.

As a result, the sound pressure indicated by the bar 802 becomes relatively smaller than that indicated by the bar 801. As a result, the sound image 800 moves rearward or to the side of the listener 304, and the listener 304 feels as though the sound is coming from the sound image 800.

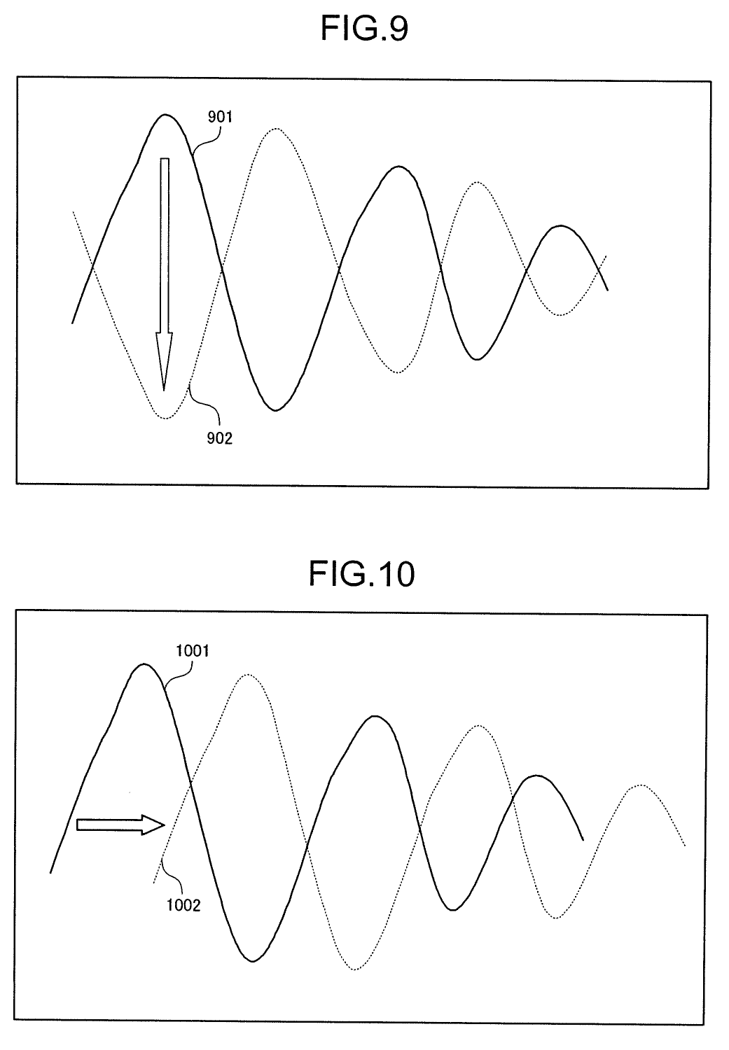

FIG. 9 is an explanatory diagram of reversed-phase sound. To decrease a level at the right ear as shown in FIG. 8, usually, sound of which phase is reverse to that of the sound output from the speaker 302 is output from the speaker 303, thereby decreasing the level at the right ear. In other words, a phase of a signal represented by a curve 901 is reversed to generate a signal represented by a curve 902, and the signal represented by the curve 902 is weakened to be superimposed on the signal represented by the curve 901, thereby decreasing the signal level as shown in the bar 802.

FIG. 10 is an explanatory diagram of a case in which delay is applied. Although the level is decreased by outputting the reverse-phase sound in the case of FIG. 9, in the present example shown in FIG. 10, a level of sound indicated by a curve 1001 and output from the speaker 302 is not changed, but the phase thereof is shifted to generate a signal indicated by a curve 1002. The signal indicated by the curve 1002 is weakened, and then output to the speaker 303.

Thus, a waveform to which delay is applied is shifted, thereby achieving substantially same effect as the case in which the phase is reversed. In other words, an interaural level difference is changed, thereby enabling the position of the sound image to be changed. Since in actuality, wavelengths differ according to band, effective delay levels differ. Therefore, delay is applied independently according to each band.

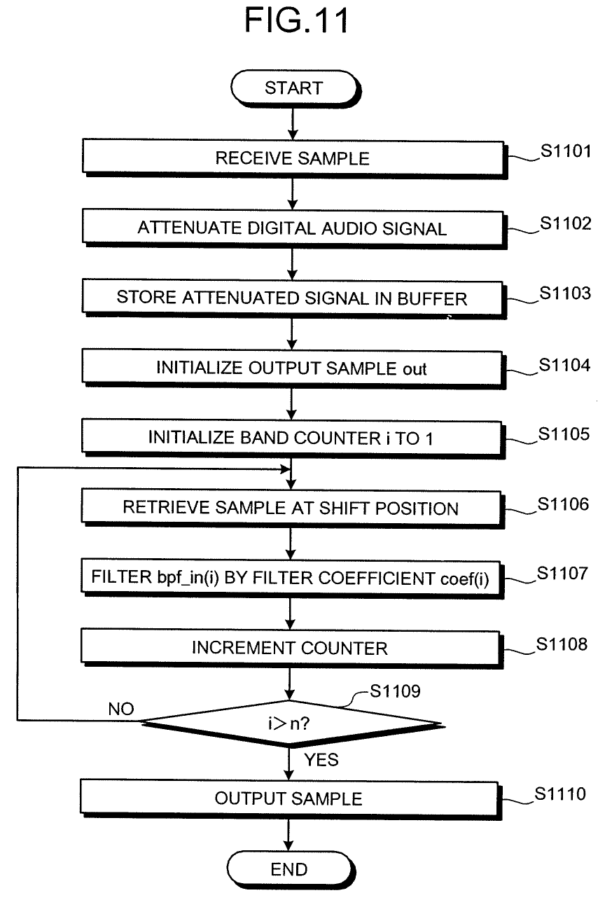

FIG. 11 is a flowchart for explaining sound-localization control processing. A sample is received (step S1101). In other words, a processor receives a digital audio signal, and stores the digital audio signal in in. The digital audio signal is attenuated (step S1102). In other words, the digital audio signal stored in in is multiplied by the ATT that is a fixed attenuation signal, and a value a_in is obtained. Usually, ATT ranged from 0 to 1 is used, e.g., ATT=0.5.

The attenuated signal is stored in a buffer (step S1103). In other words, a_in is stored in a buffer c_buffer( ) for delay. Usually, a circular buffer of a fixed length is used as the buffer. An output sample out is initialized (step S1104).

A band counter i is initialized to 1 (step S1105). The band is divided into six band-divisions having center frequencies of 125, 250, 500, 1 k, 2 k, and 4 k (Hz). At this time, a bandwidth of each bandpass filter is 1/10 ct. It is desirable to use a linear-phase FIR filter as the filter, but IIR may be substituted when calculation amount is to be reduced.

A sample at a shift position is retrieved (step S1106). Specifically, in c_buffer( ), a sample that is d(i) samples before the current time is retrieved and regarded as a value bpf_in(i). As shown in FIG. 5, the sample passes though the bandpass filter after delay is applied thereto. As a result, there is no need to provide a buffer for each band compared to the case in which the delay is applied afterward. The delay may be applied after the processing by the bandpass filter.

bpf_in(i) is filtered using a filter coefficient coef(i) (the filter coefficient is a vector value) (step S1107). The counter is incremented (step S1108). Specifically, a value of i is incremented by 1.

It is determined whether i is greater than n (here, 6) (step S1109). When i is not greater than n (step S1109: NO), the process returns to step S1106. When i is greater than n (step S1109: YES), the sample is output (step S1110). At this time, the sample is output to a channel corresponding to the right speaker (the left speaker in the case of SR input), and a series of processing ends. When the next sampling time has come, the processing is repeated from the beginning again.

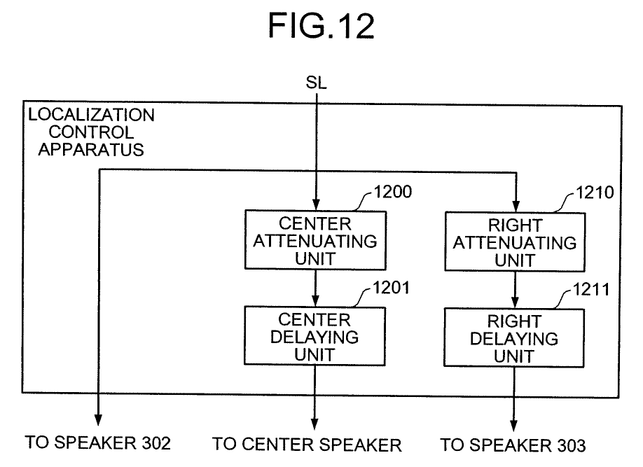

FIG. 12 is a block diagram for explaining a configuration of the localization control apparatus when playing back middle-to-high frequency sound with other speakers. A signal represented by SL is input to the localization control apparatus 301. SL is output as it is to the speaker 302 disposed on the left side of the listener 304. On the other hand, the same signal is input to a center attenuating unit 1200 and a right attenuating unit 1210.

The center attenuating unit 1200 and the right attenuating unit 1210 attenuate the input signals by multiplying the input signals by a given coefficient ATT. The coefficient ATT has a range of 0 to 1, and for example, can be ATT=0.5. The center attenuating unit 1200 attenuates the signal represented by SL by ATT, and outputs the attenuated signal to a right delaying unit 1201. The right attenuating unit 1210 attenuates the signal represented by SL by ATT, and outputs the attenuated signal to a right delaying unit 1211.

The center delaying unit 1200 and the right delaying unit 1210 each has the same configuration as the delaying unit 510 shown in FIG. 5, and includes the delay device 511 and the bandpass filter 512. The center delaying unit 1200 and the right delaying unit 1210 perform the filtering and the delaying according to the number of divided bands, and the combining and the outputting by the delay device 511 and the bandpass filter 512. The center delaying unit 1201 outputs the signal to the non-depicted center speaker, and the right delaying unit 1211 outputs the signal to the speaker 303.

According to the above example, the configuration of the localization control apparatus is simple such that one parameter is provided for one band, thereby achieving easy tuning and customizing of a coefficient according to the circumstances of each person. Therefore, a filter coefficient can be easily generated according to a transmission characteristic, which varies according to listener, such as differing listening circumstances and head shapes. Even if sound for which a phase difference is changed is played back with one speaker, a difference in sound quality from the original sound can be hardly recognized. Therefore, localization control without drastically changing the sound quality of the original sound is enabled.

Even when a logically optimal solution does not always exist in the specialized case of a front surround system, not a logically optimal solution, but a subjectively optimal solution can be found. And a sound image can be localized according to this optimal solution.

Since one parameter is provided for one band with respect to head shape and playback circumstances that differ according to user, and setting by an auditory sense is easy, personalization is easily achieved. Since there is no frequency characteristic, playback without losing original sound quality is enabled.

Since a reverse phase is not used, there is no need of redundant multiplication of multiplying (−1). Generally, a sense of reverse phase is one of the most disliked items in the technique of playing back virtual sound images. In contrast, the utilization of the method employing only delay enables playback of more natural sound and does not process the sound source more than necessary.

Even if speakers are disposed symmetrically with respect to a listener, in many cases, a coefficient causing a virtual sound image to spread most widely is not symmetrical. Circumstances of a room, asymmetry of an auditory sense, and the like are considered to be factors. However, a delay level for each band need not be symmetrical with respect to left and right. Therefore, a delay level is set independently for left and right.

A pair of two speakers can be changed for each band. Particularly, a center speaker may be used as a speaker to which delay is applied for middle-to-high frequency. The delay device and the bandpass filter may be integrated into one filter. An all-pass filter (IIR) that changes only a phase or an FIR may be used.

At a band in which a wavelength is shorter than the size of a head (middle-to-high frequency of 1.5-2 kHz), an area within which energy can be reduced by combination of waveforms is small. Therefore, even if energy is reduced at one point, in some cases, energy is increased at a neighboring point that is a few centimeters away. In some cases, the sound to be localized to the left is localized to the right speaker only if a head moves a bit.

The use of a center speaker as a speaker to which delay is applied prevents a phenomenon of reverse localization from occurring, in which sound to be localized to the left is localized to the right. The shortcoming of conventional localization control based on the HRTF in which a sense of localization becomes unstable by movement of a head can be overcome. Additionally, the volume of calculations and memory utilization of coefficients can be reduced. Furthermore, this localization control apparatus is applicable to a home theater system, a personal surround system of a PDP and the like, such as a flat screen TV, a PC, and a portable DVD player.

The localization control method explained in the present embodiment can be implemented by a computer, such as a personal computer and a workstation, executing a program that is prepared in advance. This program is recorded on a computer-readable recording medium such as a hard disk, a flexible disk, a CD-ROM, an MO, and a DVD, and is executed by being read out from the recording medium by a computer. This program can be a transmission medium that can be distributed through a network such as the Internet.

1.-9. (canceled)

10. A localization control apparatus that outputs an audio signal input thereto to a first channel among of a plurality of channels, and based on the audio signal, outputs a control signal for controlling an audio signal for a second channel among the channels, the localization control apparatus comprising:
an attenuating unit that attenuates the audio signal;
a delaying unit that, according to band, separates and delays the audio signal attenuated by the attenuating unit, and
a generating unit that generates the control signal by combining each component of the audio signal separated and delayed by the delaying unit.

11. The localization control apparatus according to claim 10, further comprising an output unit that combines the control signal with the audio signal for the second channel.

12. The localization control apparatus according to claim 10, wherein the generating unit generates the control signal for each of the channels.

13. The localization control apparatus according to claim 11, wherein the output unit changes a sound pressure level of the audio signal for the second channel and a position of a sound image sound corresponding to the audio signal, by combining the control signal with the audio signal for the second channel.

14. The localization control apparatus according to claim 10, wherein the output unit outputs the audio signal to a left speaker and the control signal to a right speaker when the audio signal is to be output to the left speaker.

15. A localization control method of outputting an audio signal input thereto to a first channel among a plurality of channels, and based on the audio signal, outputting a control signal for controlling an audio signal for a second channel among the channels, the localization control method comprising:
attenuating the audio signal;
delaying, by separating and delaying, according to band, the audio signal attenuated at the attenuating, and
generating the control signal by combining each component of the audio signal separated and delayed at the delaying.

16. The localization control method according to claim 15, further comprising outputting by combining the control signal with the audio signal for the second channel.

17. The localization control method according to claim 15, wherein the generating includes generating the control signal for each of the channels.

18. The localization control method according to claim 16, wherein the outputting includes changing a sound pressure level of the audio signal for the second channel and a position of a sound image sound corresponding to the audio signal, by combining the control signal with the audio signal for the second channel.

19. The localization control method according claim 15, wherein the outputting includes outputting the audio signal to a left speaker and the control signal to a right speaker when the audio signal is to be output to the left speaker.

20. A computer-readable recording medium storing therein a computer program that is for a localization control method of outputting an audio signal input thereto to a first channel among a plurality of channels, and based on the audio signal, outputting a control signal for controlling an audio signal for a second channel among the channels, and that causes a computer to execute:
attenuating the audio signal;
delaying, by separating and delaying, according to band, the audio signal attenuated at the attenuating, and
generating the control signal by combining each component of the audio signal separated and delayed at the delaying.

21. The computer-readable recording medium according to claim 20, wherein the computer program further causes the computer to execute outputting by combining the control signal with the audio signal for the second channel.

22. The computer-readable recording medium according to claim 20, wherein the generating includes generating the control signal for each of the channels.

23. The computer-readable recording medium according to claim 21, wherein the outputting includes changing a sound pressure level of the audio signal for the second channel and a position of a sound image sound corresponding to the audio signal, by combining the control signal with the audio signal for the second channel.

24. The computer-readable recording medium according claim 20, wherein the outputting includes outputting the audio signal to a left speaker and the control signal to a right speaker when the audio signal is to be output to the left speaker.
